(19) United States
(12) Patent Application Publication
(10) Pub. No.: US 2010/0000615 A1
(43) Pub. Date: Jan. 7, 2010

(54) LEAK DETECTION AND SHUTOFF SYSTEM

(76) Inventor: Charles Finlayson, Key West, FL (US)

Correspondence Address: ALBERT BORDAS, P.A., 5975 SUNSET DRIVE, SUITE 607, MIAMI, FL, 33143, US

(21) Appl. No.: 12/167,888

(22) Filed: Jul. 3, 2008

(51) Int. Cl. F16K 15/00

(52) U.S. Cl. 137/487.5

(57) ABSTRACT

An automatic leak detection and shutoff system for plumbing systems that detects a flow of water that endures longer than a user sets as normal, and shuts off the flow of water when it detects that water has flowed too long. Water flow can be restored by pressing a reset button.

### BACKGROUND OF THE INVENTION

1. Field of the Invention

The present invention relates to plumbing systems, and more particularly, to an automatic leak detection and shutoff system for water systems.

2. Description of the Related Art

Water damage frequently occurs when a faucet or pipe of a plumbing system fails, resulting in much damage to building structures and their contents, such as but not limited to, furniture and electrical systems. Furthermore, water conservation is of extreme importance for the preservation of the earth. Applicant is not aware of an automatic leak detection and shutoff system for water systems comprising the innovation presented below.

### SUMMARY OF THE INVENTION

The instant invention is a leak detection and shutoff system that in a preferred embodiment is implemented within a plumbing system. It comprises a flow switch that detects water flow and an electrical system. The electrical system comprises a first solenoid valve, a first relay, a first power supply, and a first timer.

The first timer is programmed to time a first predetermined time span for water flow to flow through the flow switch. The first timer sends an electronic signal to close the first solenoid valve, causing the water flow to cease when the first predetermined time span expires. The instant invention further comprises resetting means. The resetting means resets the first solenoid valve, and the first timer to reset the first predetermined time span. Changing means allow for changing the first predetermined time span. The changing means comprises at least one dipswitch. The at least one dipswitch increases the first predetermined time span when activated, and decreases the first predetermined time span when deactivated. A manual bypass to allow the water flow to flow if the first solenoid valve closes. Resetting means can comprise a reset button or a remote radio reset.

The electrical system further comprises a second solenoid valve, second and third relays, and second and third timers. The second timer is programmed to time a second predetermined time span and the third timer is programmed to time a third predetermined time span when the water flow flows through the flow switch. The second relay causes the second timer to zero and the third relay energizes the first timer to reset the first predetermined time span. Energizing the second relay opens the second solenoid valve. The flow switch remains closed when a first predetermined water flow flows, and the flow switch opens when a second predetermined water flow flows once a fourth predetermined time span expires. The third timer maintains the second solenoid valve open for a fifth predetermined time span, and after the fifth predetermined time span expires, the second solenoid valve closes to reset the second predetermined time span. The second predetermined time span is reset to keep the first timer timing while the flow switch detects water flow after the second solenoid valve closes. If there is water flow a sixth predetermine time after the second solenoid valve closes, the flow switch recluses and the second predetermined time span is accumulated and continuous with the previous close timed by the first timer.

It is therefore one of the main objects of the present invention to provide a leak detection and shutoff system that automatically detects water flow.

It is another object of this invention to provide a leak detection and shutoff system that automatically shuts off water flow when programmed to.

It is another object of this invention to provide a leak detection and shutoff system that allows a user to set a predetermined amount of time that water is expected to be used.

It is another object of this invention to provide a leak detection and shutoff system comprising an electronic timing unit that monitors the time that a flow switch detects water flow.

It is another object of this invention to provide a leak detection and shutoff system comprising a reset button for a user to restore water flow, reset a timer, and if flow is detected, starts another new timing cycle.

It is yet another object of this invention to provide such a system that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a schematic of a plumbing system used with the present invention.

FIG. 2 is an electrical schematic of the present invention as seen in FIG. 1.

FIG. 3 is a schematic of a plumbing system used with a first alternate embodiment of the present invention.

FIG. 4 is an electrical schematic of the first alternate embodiment of the present invention as seen in FIG. 3.

FIG. 5 is an electrical schematic of a second alternate embodiment of the present invention.

### DETAILED DESCRIPTION OF THE PREFERRED EMBODIMENT

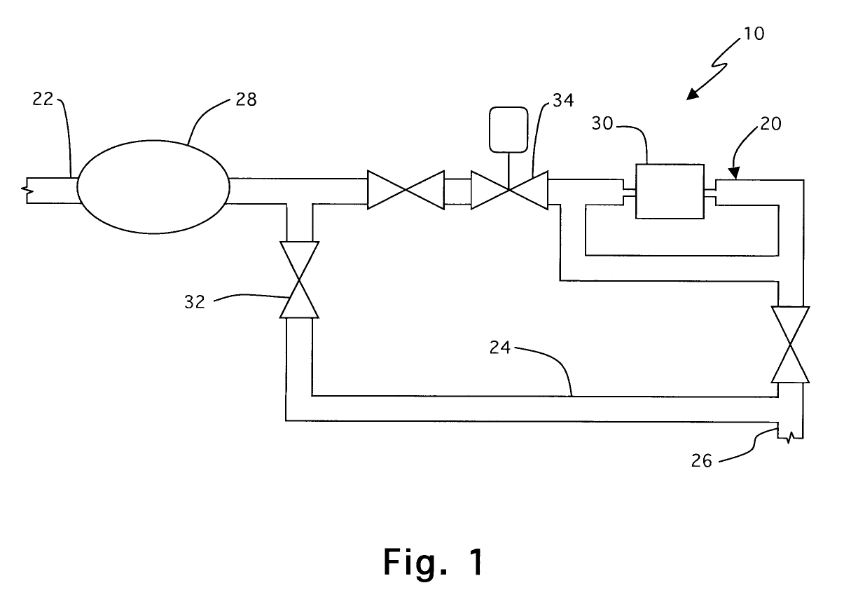

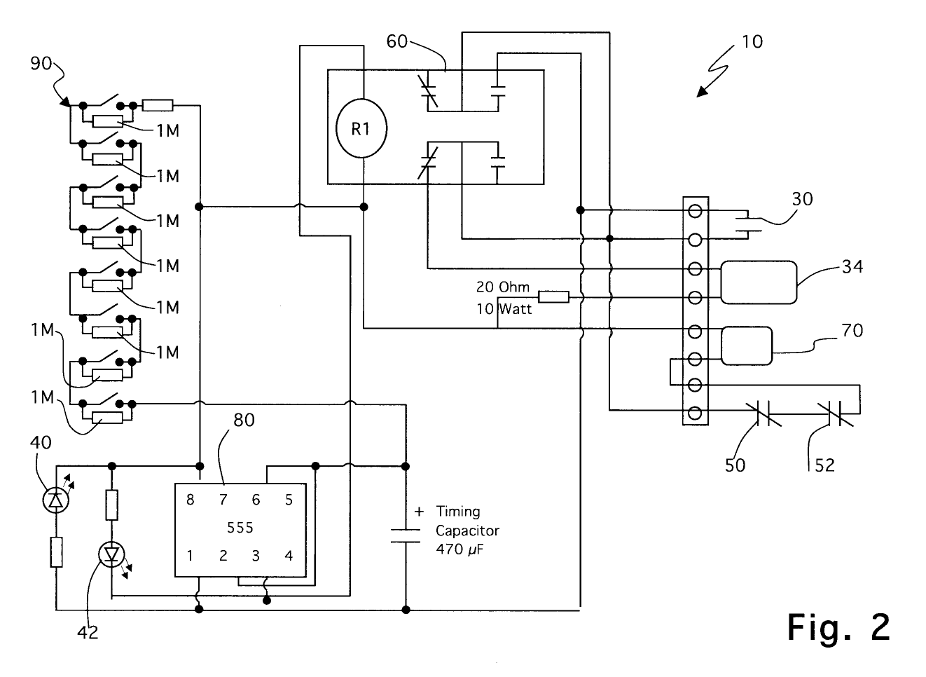

Referring now to the drawings, the present invention is generally referred to with numeral 10. As seen in FIGS. 1 and 2, instant invention 10 is a leak detection and shutoff system. Instant invention 10 is installed within plumbing system 20 that has a normally intermittent mode of operation. Generally, plumbing system 20 comprises at least pipes 22; 24; and 26. In this illustration, pipe 22 originates from a water source and terminates at water meter 28, pipes 24 extend and connect throughout instant invention 10. It is noted that one section of pipe 24 serves as a bypass pipe. Pipe 26 terminates within a residence or commercial establishment. In the preferred embodiment, instant invention 10 is installed in a residential plumbing system. However, as mentioned above, instant invention 10 can also be installed within commercial plumbing systems or any other plumbing system that has a normally intermittent mode of operation.

Generally, instant invention 10 detects an actual water flow that endures longer than a user sets as normal, and with an electrical system, automatically shuts off the water flow when it detects that it has flowed too long. Activating reset button 50 can restore the water flow, defining resetting means. The user can view water flow indicator 40 or shutoff indicator 42 to check the status of instant invention 10.

In operation, the user sets a maximum amount of time that water is expected to be used. As an example, such water to be used is for bathing, watering a lawn, operating a washing machine or a dishwashing machine. Flow switch 30 detects the water flow. Timer 80 monitors the time that flow switch 30 detects water flow. If water flow endures longer than the time selected by the user, it sends an electronic signal to solenoid valve 34, activating it to close, thus stopping the water flow. Pressing reset button 50 restores water flow and resets timer 80, and if flow is detected, timer 80 starts another timing cycle. Instant invention 10 may also comprise remote radio reset 52 to restore water flow and resets timer 80. It is presumed that if the user does not have a reasonable explanation as to why the water flow exceeded their expectation, the user can reevaluate a set point or look for a leak within plumbing system 20.

As an example of the instant invention 10 seen in FIGS. 1 and 2, when water flows in excess of about 0.016 gal/min (about ¼ cup a minute), a contact in flow switch 30 closes. This causes a power supply to be energized in a timing circuit, causing timer 80 to begin timing. For this example, the user selects a maximum amount of time water should flow by moving switches on an eight-position switch of dipswitches 90, defining changing means. Each switch moved to open, adds more time to the set point. This set point can be arrived at by use. If the user experiences to many false shutoffs, the user can move another switch to an open position. On the other hand, if the set point is never reached the user can move a switch to a closed position to reduce the time water would flow in the event there was a leak. Typically, leaks are caused by broken or cracked washing machine hoses, broken or cracked garden hoses, over-running toilets, or valves left open or partially open.

In the preferred embodiment, the set point can be approximately between four minutes to an hour. If flow continues without interruption for a period of time longer than the set point established by the user, pin 3 of the 555 chip, as seen in FIG. 2, will go to a “low” state. This pin is connected to one side of relay 60. The other side of relay 60 is connected to positive power supply 70. Such a power supply can be a 12 VDC, as an example. This results in relay 60 becoming energized, which opens a normally closed contact supplying solenoid valve 34. This lets solenoid valve 34 go to a de-energized state, which is closed. This stops water flow. When relay 60 energizes it, it also closes a normally open contact, which seals negative (zero), power supply 70 to pin 1 of the 555 chip. This causes relay 60 to remain in its energized state and keep the normally closed contact open, de-energizing and closing solenoid valve 34. Water remains shut off until the user presses reset button 50, which deenergizes the 555 chip, thus allowing relay 60 to be deenergized. This closes the normally closed contact of solenoid valve 34, and causes it to open. Water can then flow and normal operation is restored. If desired, manual bypass 32 may be engaged to allow water to flow to pipe 26, bypassing solenoid valve 34.

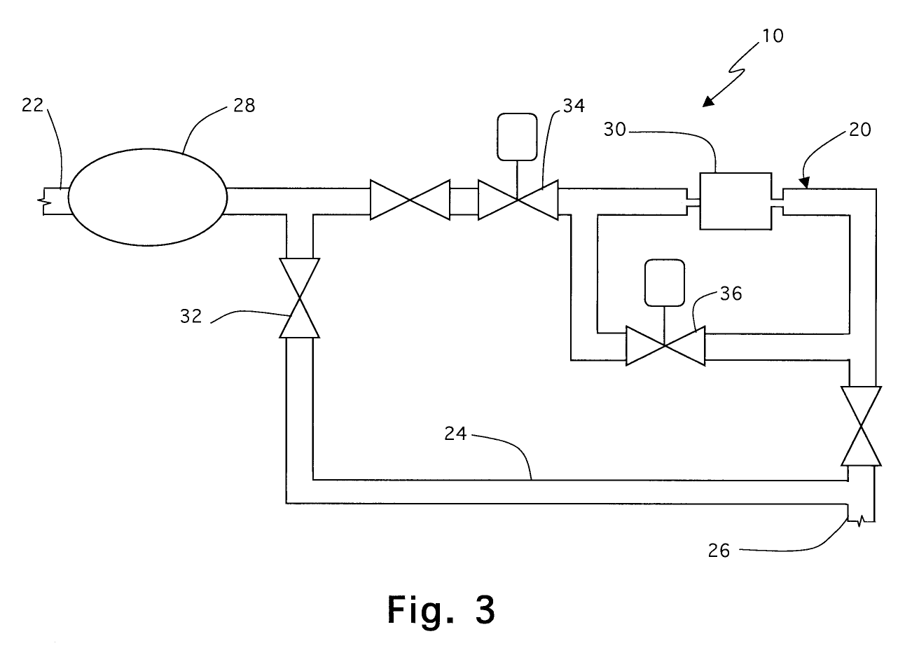

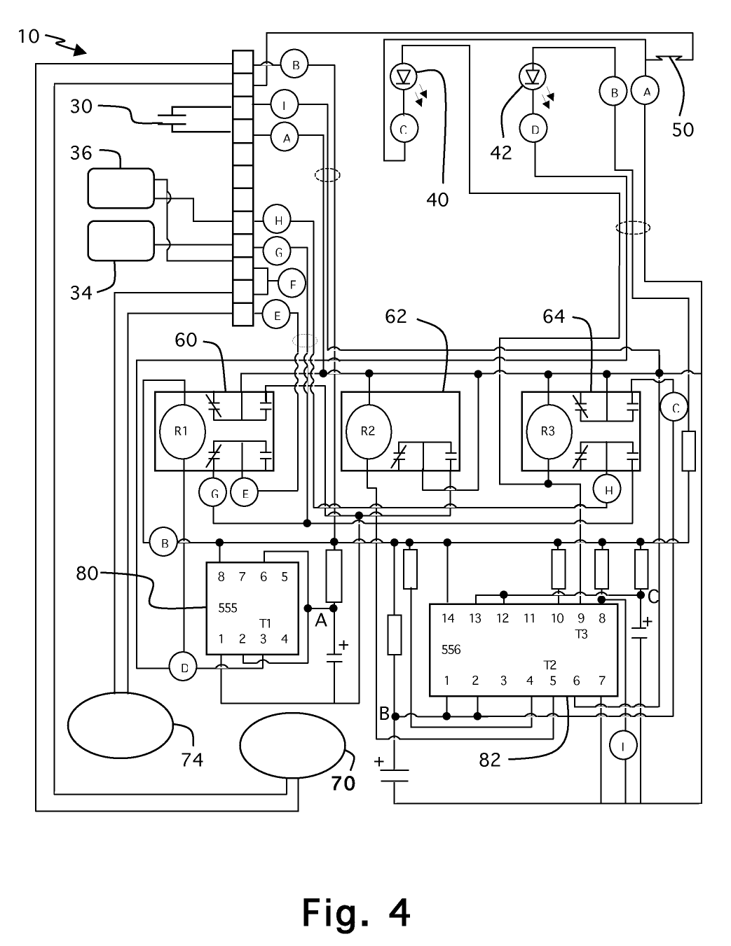

FIGS. 3 and 4 illustrate a first alternate embodiment of the present invention, whereby instant invention 10 further comprises solenoid valve 36. When instant invention 10 is energized solenoid valve 34 is always open unless timer 80 sends an electronic signal, activating it to close, thus stopping the water flow. If no water is flowing through pipe 26, the contact of flow switch 30 is open. When solenoid valve 36 is closed, all water must flow through flow switch 30.

As an example of the instant invention 10 seen in FIGS. 3 and 4, when water flows through flow switch 30 in excess of 3 ccm (0.0008 gal/min or 0.1 ounce/min) the contact in flow switch 30 closes. This causes T2 and T3 of timer 82 to begin timing and relays 62 and 64 to pick up. Relay 64 forces T2 time to zero. Relay 62 causes a negative (zero) VDC to be energized in the T1 timing circuit of timer 80. This causes the length of continuous water flow to be timed by timer 80.

Energizing relay 64 opens solenoid valve 36. As an example, if the flow is greater than 0.016 gal/min (¼ cup/min), flow switch 30 will stay closed. If the flow is smaller than 0.016 gal/min, flow switch 30 will open after a short period of time. T3 holds solenoid valve 36 open for a minimum amount of time and when it times out, solenoid valve 36 closes and timing begins on T2. The purpose of T2 is to keep timer 80 timing while flow switch 30 checks for water flow after solenoid valve 36 closes. If there is water flow a short time after solenoid valve 36 closes, flow switch 30 recluses and the time is accumulated as continuous with the previous close of timer 80. In the event of a water leak less than 0.016 gal/min, this causes a slow oscillation of flow switch 30 and solenoid valve 36, but the time is continuously recorded in timer 80.

As detailed above, the set point can be approximately between four minutes to an hour. If flow continues without interruption for a period of time longer than the set point established by the user, pin 3 of the 555 chip, as seen in FIG. 4, will go to a “low” state. This pin is connected to one side of relay 60. The other side of relay 60 is connected to positive power supply 70. Such a power supply can be a 12 VDC, as an example. This results in relay 60 becoming energized, which opens a normally closed contact supplying solenoid valve 34. This lets solenoid valve 34 go to a de-energized state, which is closed. This stops water flow. When relay 60 energizes it, it also closes a normally open contact, which seals negative (zero), power supply 70 to pin 1 of the 555 chip. This causes relay 60 to remain in its energized state and keep the normally closed contact open, de-energizing and closing solenoid valve 34. Water remains shut off until the user presses reset button 50, which deenergizes the 555 chip, thus allowing relay 60 to be deenergized. This closes the normally closed contact of solenoid valve 34, and causes it to open. Water can then flow and normal operation is restored. If desired, manual bypass 32 may be engaged to allow water to flow to pipe 26, bypassing solenoid valve 34.

As seen in FIG. 4, transformer 74 may be integrated into instant invention 10. Such a transformer can be a twenty-four VAC transformer as an example.

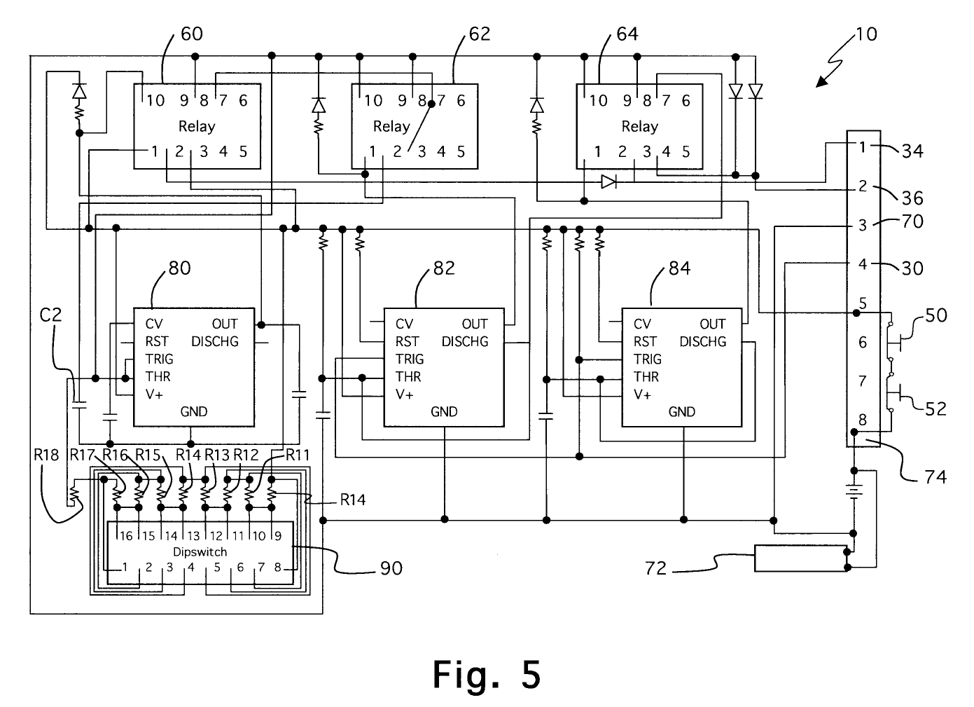

As seen in FIG. 5, still another embodiment comprises power supply 72 that may be integrated into instant invention 10. Such a power supply can be a battery and charger that can be recharged by a solar or AC charger as an example.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A leak detection and shutoff system in combination with a plumbing system, comprising:
A) a flow switch that detects water flow; and
B) an electrical system comprising a first solenoid valve, a first relay, a first power supply, and a first timer, said first timer is programmed to time a first predetermined time span for said water flow to flow through said flow switch, said first timer sends an electronic signal to close said first solenoid valve, causing said water flow to cease when said first predetermined time span expires.

2. The leak detection and shutoff system in combination with a plumbing system set forth in claim 1, further comprising resetting means.

3. The leak detection and shutoff system in combination with a plumbing system set forth in claim 2, further characterized in that said resetting means resets said first solenoid valve and said first timer to reset said first predetermined time span.

4. The leak detection and shutoff system in combination with a plumbing system set forth in claim 1, further comprising changing means to change said first predetermined time span.

5. The leak detection and shutoff system in combination with a plumbing system set forth in claim 4, further characterized in that said changing means comprises at least one dipswitch, said at least one dipswitch increases said first predetermined time span when activated, and said at least one dipswitch decreases said first predetermined time span when deactivated.

6. The leak detection and shutoff system in combination with a plumbing system set forth in claim 1, further comprising a manual bypass to allow said water flow to flow if said first solenoid valve closes.

7. A leak detection and shutoff system in combination with a plumbing system, comprising:
A) a flow switch that detects water flow;
B) an electrical system comprising a first solenoid valve, a first power supply, and a first timer, said first timer is programmed to time a first predetermined time span for said water flow to flow through said flow switch, said first timer sends an electronic signal to close said first solenoid valve, causing said water flow to cease when said first predetermined time span expires; and
C) changing means to change said first predetermined time span, said changing means comprises at least one dipswitch, said at least one dipswitch increases said first predetermined time span when activated, and said at least one dipswitch decreases said first predetermined time span when deactivated.

8. The leak detection and shutoff system in combination with a plumbing system set forth in claim 7, further comprising a reset button.

9. The leak detection and shutoff system in combination with a plumbing system set forth in claim 8, further characterized in that said reset button resets said first solenoid valve and said first timer to reset said first predetermined time span.

10. The leak detection and shutoff system in combination with a plumbing system set forth in claim 7, further comprising a remote radio reset.

11. The leak detection and shutoff system in combination with a plumbing system set forth in claim 10, further characterized in that said remote radio reset resets said first solenoid valve and said first timer to reset said first predetermined time span.

12. The leak detection and shutoff system in combination with a plumbing system set forth in claim 9, further comprising a manual bypass to allow said water flow to flow if said first solenoid valve closes.

13. The leak detection and shutoff system in combination with a plumbing system set forth in claim 11, further comprising a manual bypass to allow said water flow to flow if said first solenoid valve closes.

14. The leak detection and shutoff system in combination with a plumbing system set forth in claim 7, further characterized in that said electrical system further comprises a second solenoid valve, second and third relays, and second and third timers.

15. The leak detection and shutoff system in combination with a plumbing system set forth in claim 14, further characterized in that said second timer is programmed to time a second predetermined time span and said third timer is programmed to time a third predetermined time span when said water flow flows through said flow switch.

16. The leak detection and shutoff system in combination with a plumbing system set forth in claim 15, further characterized in that said second relay causes said second timer to zero and said third relay energizes said first timer to reset said first predetermined time span.

17. The leak detection and shutoff system in combination with a plumbing system set forth in claim 16, further characterized in that energizing said second relay opens said second solenoid valve.

18. The leak detection and shutoff system in combination with a plumbing system set forth in claim 17, further characterized in that said flow switch remains closed when a first predetermined water flow flows, and said flow switch opens when a second predetermined water flow flows once a fourth predetermined time span expires.

19. The leak detection and shutoff system in combination with a plumbing system set forth in claim 18, further characterized in that said third timer maintains said second solenoid valve open for a fifth predetermined time span, and after said fifth predetermined time span expires, said second solenoid valve closes to reset said second predetermined time span.

20. The leak detection and shutoff system in combination with a plumbing system set forth in claim 19, further characterized in that said second predetermined time span is reset to keep said first timer timing while said flow switch detects said water flow after said second solenoid valve closes, if there is said water flow a sixth predetermine time after said second solenoid valve closes, said flow switch recluses and said second predetermined time span is accumulated and continuous with the previous close timed by said first timer.
